(19) United States
(12) Patent Application Publication
(10) Pub. No.: US 2016/0210929 A1
(43) Pub. Date: Jul. 21, 2016

(54) DISPLAY AND TOUCH DISPLAY

(71) Applicant: Chunghwa Picture Tubes, LTD., Taoyuan City (TW)

(72) Inventors: Hu-Yi Liu, Taoyuan City (TW); Hsin-Chung Huang, New Taipei City (TW)

(21) Appl. No.: 14/688,870

(22) Filed: Apr. 16, 2015

(30) Foreign Application Priority Data
Jan. 21, 2015 (TW) 104101937

(51) Int. Cl. G09G 3/36; G09G 5/18; G09G 5/10; G06F 3/041

(52) U.S. Cl. CPC G09G 3/3696; G06F 3/0416; G09G 5/18; G09G 5/10

(57) ABSTRACT

A display and a touch display are provided. The display includes a display panel and a source driver. The display panel includes pixels and a common electrode receiving a common voltage. The source driver is configured to provide current pixel voltages to the pixels and determine whether to insert at least one intermediate voltage level between each of the current pixel voltages and the corresponding previous pixel voltage based on the each of the current pixel voltages and the corresponding previous pixel voltage.

### CROSS-REFERENCE TO RELATED APPLICATION

This application claims the priority benefit of Taiwan application serial no. 104101937, filed on Jan. 21, 2015. The entirety of the above-mentioned patent application is hereby incorporated by reference herein and made a part of this specification.

### BACKGROUND

1. Field of the Invention

The invention is directed to a display and more particularly, to a display and a touch display capable of adjusting pixel voltages stepwise.

2. Description of Related Art

In recent years, the development of flat panel display technology has continuously progressed, such that liquid crystal displays (LCDs) have been widely applied in various fields. The liquid crystal has to be driven by means of frequently inverting polarities of pixel voltages. Thus, during the inversion of the polarity, the pixel voltages would have higher voltage variation, and the voltage variation causes affection to a level of a common electrode due to a capacitance coupling effect, such that the display effect of the LCDs are also affected. Therefore, how to mitigate the affection caused by the voltage variation of the pixel voltages to the common electrode is important to LCD design.

### SUMMARY

Accordingly, the invention provides a display and a touch display capable of providing pixel voltages applied to pixels stepwise; so as to mitigate the affection caused by variation of the pixel voltages to image display and detection of touch points.

According to an embodiment, the invention provides a display, including a display panel and a source driver. The display panel has a plurality of pixels and a common electrode receiving a common voltage. The source driver is configured to provide a plurality of current pixel voltages to the pixels and determine whether to insert at least one intermediate voltage level between each of the current pixel voltages and a previous pixel voltage corresponding thereto based on each of the current pixel voltages and the corresponding previous pixel voltage.

According to an embodiment, the invention provides a touch display, including a display panel, a touch panel and a source driver. The display panel has a plurality of pixels and a common electrode receiving a common voltage. The touch panel is disposed on the display panel and has a plurality of touch electrodes. The source driver is configured to provide a plurality of current pixel voltages to the pixels and determine whether to insert at least one intermediate voltage level between each of the current pixel voltages and a previous pixel voltage corresponding thereto based on each of the current pixel voltages and the corresponding previous pixel voltage.

To sum up, in the display and the touch display according to the embodiments of the invention, when the pixel voltages are adjusting, the intermediate voltages can be inserted according to the polarity change or variation degrees of the pixel voltages. Thereby, the pixel voltages applied to the pixels can be adjusted stepwise, so as to prevent the quality of displaying the image and the operability of the touch operation from being affected due to variation in the pixel voltages.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram illustrating a display according to an embodiment of the invention.

FIG. 2 is a schematic system diagram illustrating the source driver according to an embodiment of the invention.

FIG. 3 is a waveform chart of the pixel voltages and the common voltages according to an embodiment of the invention.

FIG. 4 is a waveform chart of the pixel voltage and the common voltage according to another embodiment of the invention.

FIG. 5 is a waveform chart of the pixel voltages according to another embodiment of the invention.

FIG. 6 is a schematic system diagram illustrating a touch display according to an embodiment of the invention.

FIG. 7 is a schematic diagram illustrating the touch panel interfered by the pixel voltages according to an embodiment of the invention.

### DESCRIPTION OF EMBODIMENTS

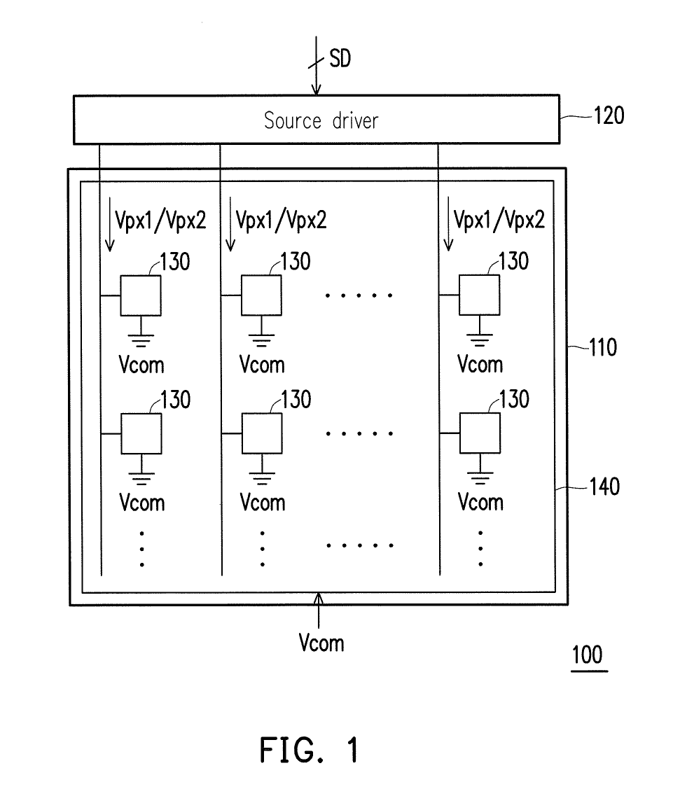

FIG. 1 is a schematic system diagram illustrating a display according to an embodiment of the invention. With reference to FIG. 1, in the present embodiment, a display 100 includes a display panel 110 and a source driver 120. The display panel 110 has a plurality of pixels 130 and a common electrode 140. The source driver 120 is coupled to the display panel 110. The source driver 120 is configured to provide a plurality of current pixel voltages Vpx1 to the pixels 130, so as to drive the display panel 110 to display an image according to a frame data SD received thereby. The common electrode 140 is configured to receive a common voltage Vcom to provide the common voltage Vcom to the pixels 130. The common electrode 140 may be a sheet electrode or include a plurality of strip electrodes, which is no limited in the present invention.

Generally, brightness displayed by each of the pixels 130 is determined according to a voltage difference between each of the current pixel voltages Vpx1 and the common voltage Vcom, and thereby, the brightness required by the display panel 110 for displaying an image is determined. Thus, in a scenario where the display panel 110 is driven in a normally white display mode, the brightness displayed by the pixels 130 becomes higher as the voltage difference between each of the pixel voltages Vpx1 and the common electrode 140 is smaller, and the brightness displayed by the pixels 130 becomes lower as the voltage difference between each of the pixel voltages Vpx1 and the common electrode 140 is greater, which operates in the opposite way in a scenario where the display panel 110 is driven in a normally black display mode.

In FIG. 1, when the voltage applied to one of the pixels 130 is changed (e.g., from a previous pixel voltage Vpx2 to the current pixel voltage Vpx1), the source driver 120 may determine whether to insert an intermediate voltage level between the corresponding one of the current pixel voltages Vpx1 and the corresponding previous pixel voltage Vpx2 according to each of the current pixel voltages Vpx1 and the corresponding previous pixel voltage Vpx2.

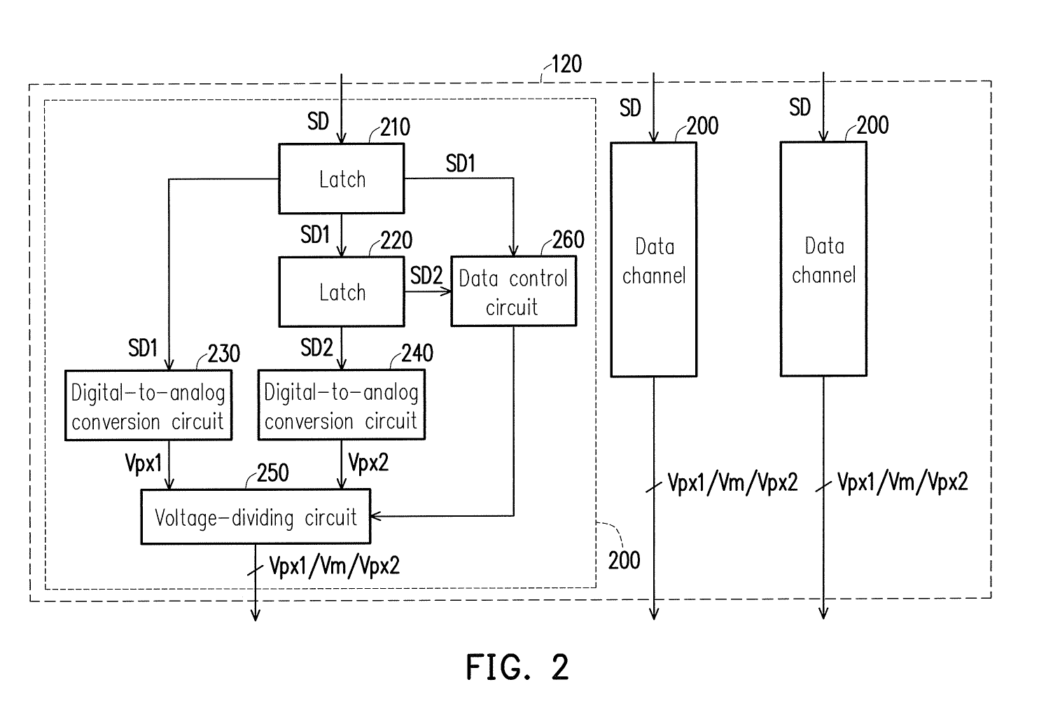

In more detail, FIG. 2 is a schematic system diagram illustrating the source driver according to an embodiment of the invention. With reference to FIG. 1 and FIG. 2, the same or similar elements are indicated by the same or similar reference labels. In the present embodiment, the source driver 120 includes a plurality of data channels 200, and each of the data channels 200 includes latches 210 and 220, digital-to-analog conversion circuits 230 and 240, a voltage-dividing circuit 250 and a data control circuit 260. The latch 210 is configured to receive a frame data SD to provide a corresponding frame data SD1 to the digital-to-analog conversion circuit 230, the latch 220 and the data control circuit 260. The latch 220 is coupled to the latch 210 to receive the frame data SD1 and provide a frame data SD2 to the digital-to-analog conversion circuit 240 and the data control circuit 260.

When providing the frame data SD1 to the digital-to-analog conversion circuit 230, the latch 220 provides the frame data SD2 to the digital-to-analog conversion circuit 240. The frame data SD1 may be considered as the current frame data, and the frame data SD2 may be considered as the previous frame data. After receiving the frame data SD1 and the frame data, SD2, the digital-to-analog conversion circuits 230 and 240 respectively provide a current pixel voltage Vpx1 (corresponding to the frame data SD1) and a previous pixel voltage Vpx2 (corresponding to the frame data SD2).

The voltage-dividing circuit 250 is coupled to the digital-to-analog conversion circuits 230 and 240 and configured to divide a voltage according to a voltage difference between the received current pixel voltages Vpx1 and the corresponding previous pixel voltage Vpx2 to generate the intermediate voltage level Vm between the current pixel voltages Vpx1 and the previous pixel voltage Vpx2.

The data control circuit 260 is coupled to the latches 210 and 220 and the voltage-dividing circuit 250 to receive the frame data SD1 and the frame data SD2. Thereby, the data control circuit 260 may determine the previous pixel voltage Vpx2 and the current pixel voltages Vpx1 according to the frame data SD1 and the frame data SD2 and then determine whether to insert the intermediate voltage level Vm between times of providing the current pixel voltage Vpx1 and the previous pixel voltage Vpx2 according to the current pixel voltage Vpx1 and the corresponding previous pixel voltage Vpx2. In other words, when determining not to insert the intermediate voltage level Vm, the data control circuit 260 controls the voltage-dividing circuit 250 to output the current pixel voltage Vpx1, and when determining to insert the intermediate voltage level Vm, the data control circuit 260 controls the voltage-dividing circuit 250 to sequentially output the intermediate voltage level Vm and the current pixel voltage Vpx1.

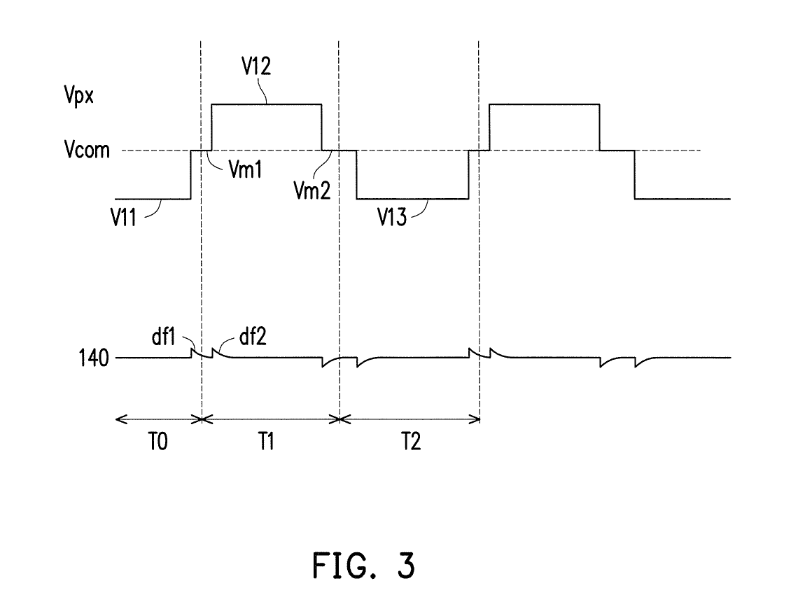

An example is provided below to illustrate the operation of the data control circuit 260 inserting the intermediate voltage level. FIG. 3 is a waveform chart of the pixel voltages and the common voltages according to an embodiment of the invention. With reference to FIG. 2 and FIG. 3, in the present embodiment, it is assumed that the pixel voltages Vpx in adjacent data write periods (e.g., periods T0 to T2) have different polarities, and in this case, the data control circuit 260 determines to insert intermediate voltage levels (e.g., Vm1, Vm2), where the data write periods (e.g., the periods T0 to T2) are respectively a horizontal scanning period. Furthermore, in the periods T0 and T1, the pixel voltages Vpx rise up from a voltage level V11 (corresponding to the previous pixel voltage) having a negative polarity to a voltage level V12 (corresponding to the current pixel voltages) having a positive polarity. Due to the pixel voltages Vpx in the adjacent periods having different polarities, the data control circuit 260 controls the voltage-dividing circuit 250 to output the intermediate voltage level Vm1 first and then the voltage level V12, i.e., inserts the intermediate voltage level Vm1 between the voltage levels V11 and V12. Likewise, in periods T1 and T2, the pixel voltages Vpx decline from the voltage level V12 (corresponding to the previous pixel voltage) having the positive polarity to a voltage level V13 (corresponding to the current pixel voltages) having a negative polarity. Due to the pixel voltages Vpx in the adjacent periods having different polarities, the data control circuit 260 also controls the voltage-dividing circuit 250 to output the intermediate voltage level Vm2 first and then the voltage level V13, i.e., inserts the intermediate voltage level Vm2 between the voltage levels V12 and V13.

Additionally, in case the pixel voltages Vpx in adjacent periods have the same polarity, the data control circuit 260 determines whether to control the voltage-dividing circuit 250 to output the intermediate voltage levels (e.g., Vm1, Vm2) according to a voltage difference between the pixel voltages Vpx in the adjacent periods, i.e., determines whether to insert at least one intermediate voltage level (e.g., Vm1, Vm2) between the pixel voltages Vpx in the adjacent periods.

Accordingly, in each data write period (e.g., the periods T0 to T2), a voltage level of the common electrode 140 forms two pulses df1 and df2 (which may be considered as offsets of the common voltage Vcom), which contributes to decentralize affection on one single edge. Thus, in case the polarities of the pixel voltages Vpx in the adjacent periods are different, an amount of voltages coupled due to a capacitance coupling effect may be reduced by means of stepwise adjusting in the present embodiment, and thereby, the affection on the level of the common voltage Vcom may be mitigated to prevent the quality of displaying the image (in grayscale or color) from being affected.

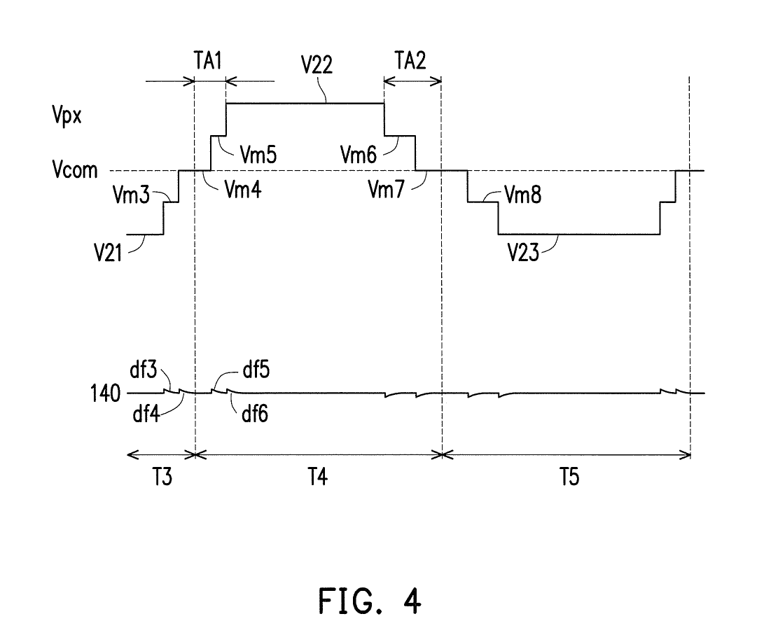

FIG. 4 is a waveform chart of the pixel voltage and the common voltage according to another embodiment of the invention. With reference to FIG. 2 to FIG. 4, the same or similar elements are indicated by the same or similar reference labels. In the present embodiment, it is assumed that the voltages Vpx in adjacent data write periods (e.g., periods T3 to T5) have different polarities, and in this case, the data control circuit 260 determines to insert intermediate voltage levels (e.g., Vm3 to Vm8).

Furthermore, in the periods T3 and T4, the pixel voltages Vpx rise up from a voltage level V21 having a negative polarity to a voltage level V22 having a positive polarity. Being different from the embodiment illustrated in FIG. 3, the data control circuit 260 controls the voltage-dividing circuit 250 to sequentially output intermediate voltage levels Vm3, Vm4, Vm5 and the voltage level V22, i.e., sequentially inserts the intermediate voltage levels Vm3, Vm4, Vm5 between the voltage levels V21 and V22. Likewise, in the periods T4 and T5, the pixel voltages Vpx decline from the voltage level V22 having the positive polarity to the voltage level V23 having the negative polarity. In the present embodiment, the data control circuit 260 controls the voltage-dividing circuit 250 to sequentially output intermediate voltage levels Vm6, Vm7, Vm8 and the voltage level V23, sequentially inserts the intermediate voltage levels Vm6, Vm7, Vm8 between the voltage levels V22 and V23.

Based on the above, in each data write period (e.g., the periods T3 to T5), the voltage level of the common electrode 240 forms four pulses df3 to df6, which further contributes to decentralize the affection on one single edge. Furthermore, pulse intensities of the pulses df3 to df6 is lower than pulse intensities of the pulses df1 and df2 illustrated in FIG. 3. Thus, in comparison with the embodiment illustrated in FIG. 3, voltage variation of the pixel voltages Vpx in the present embodiment causes less affection to the voltage level of the common electrode 240.

It should be noted that in the present embodiment, a sum of applying durations (e.g., a sum of periods TA1 and TA2) of the intermediate voltage levels (e.g., Vm3 to Vm8) in one data write period (e.g., one of T3 to T5) is less than or equal to ⅓ of one data write period, so as to prevent the applying durations of the intermediate voltage levels (e.g., Vm3 to Vm8) from affecting the image display. Meanwhile, in the present embodiment, the applying durations of the intermediate voltage levels (e.g., Vm3 to Vm8) are illustrated as unequal; in other embodiments of the invention, the applying durations of the intermediate voltage levels (e.g., Vm3 to Vm8) may be set as the same, which construes no limitations to the embodiments of the invention. In other embodiments of the invention, the number of the intermediate voltage levels inserted between the each of the pixel voltages Vpx in the adjacent periods may be adjusted according to actual needs of the technicians of the art, which construes no limitations to the embodiments of the invention.

In the present embodiment, the data control circuit 260 controls the voltage-dividing circuit 250 to output the intermediate voltage levels when the polarities of the pixel voltages Vpx in the adjacent periods are different and outputs the intermediate voltages to provide to the pixels stepwise when voltage variation of the pixel voltages is too large. Namely, the data control circuit 260 may determine whether to control the voltage-dividing circuit 250 to output the intermediate voltage levels according to a voltage difference between the pixel voltages Vpx in the adjacent periods, so as to determine whether to insert the intermediate voltage levels between the pixel voltages Vpx in the adjacent periods.

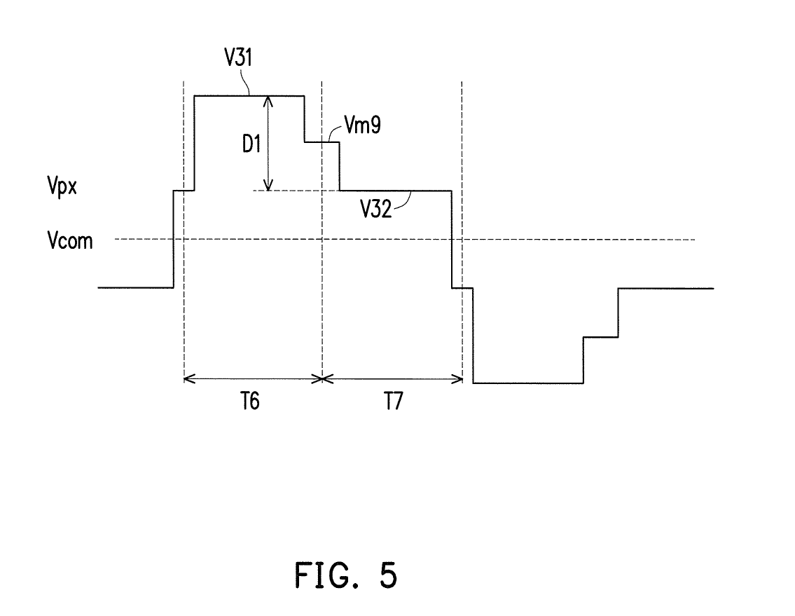

FIG. 5 is a waveform chart of the pixel voltages according to another embodiment of the invention. With reference to FIG. 2 and FIG. 5, in the present embodiment, it is assumed that the pixel voltages Vpx in periods T6 and T7 have the same polarity, and the pixel voltages Vpx decline from a voltage level V31 having a positive polarity to a voltage level V32 having the positive polarity, where a voltage difference between the voltage levels V31 and V32 having the positive polarity is D1. In the present embodiment, it is assumed that the voltage difference D1 is greater than or equal to a predetermined threshold voltage Vth. Namely, the data control circuit 260 determines that the voltage difference D1 is greater than or equal to the predetermined threshold voltage Vth, and thus, the data control circuit 260 controls the voltage-dividing circuit 250 to sequentially output an intermediate voltage level Vm9 and the voltage level V32, i.e., inserts the intermediate voltage level Vm9 between the voltage levels V31 and V32.

Additionally, when determining that the voltage difference D1 is less than the predetermined threshold voltage Vth, the data control circuit 260 controls the voltage-dividing circuit 250 not to output the intermediate voltage level Vm9, i.e., does not insert the intermediate voltage level Vm9 between the voltage levels V31 and V32. The threshold voltage Vth may be equal to ½ of the voltage difference between a voltage level of one pixel voltage Vpx corresponding to the minimum grayscale voltage (e.g., a grayscale value of 0) and a voltage level of another pixel voltage Vpx corresponding to the maximum grayscale voltage (e.g., a grayscale value of 255), and the polarities of the pixel voltages Vpx are assumed to be the same, but the invention is not limited thereto.

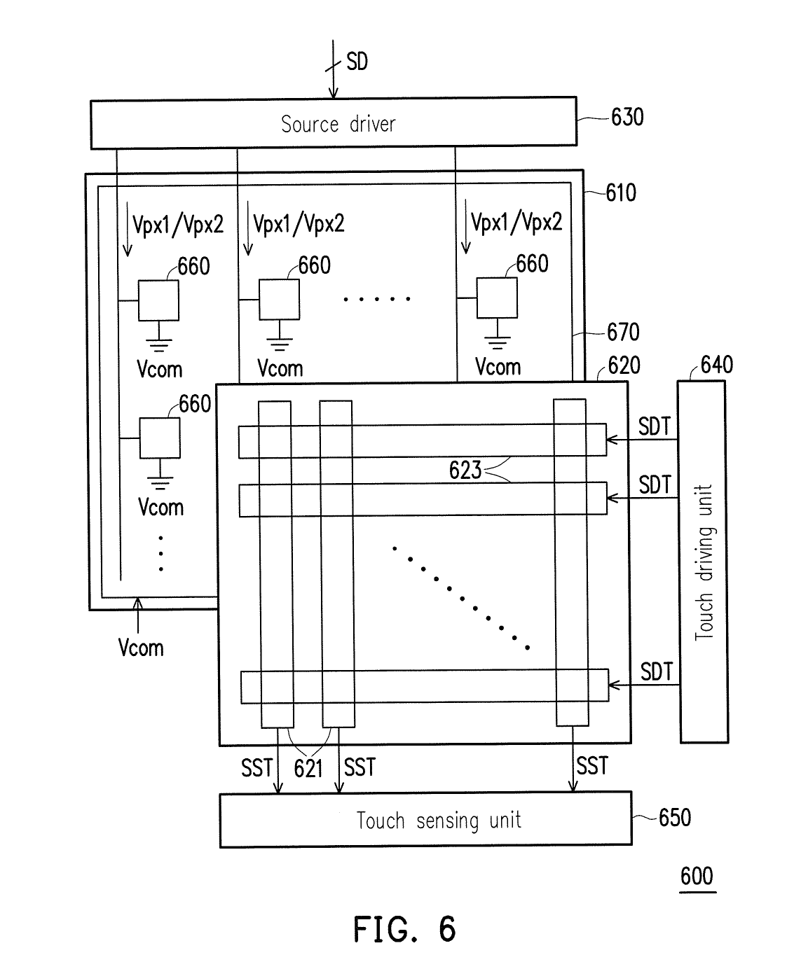

FIG. 6 is a schematic system diagram illustrating a touch display according to an embodiment of the invention. With reference to FIG. 6, in the present embodiment, a touch display 600 includes a display panel 610, a touch panel 620, a source driver 630, a touch driving unit 640 and a touch sensing unit 650. The touch panel 620 is disposed on the display panel 610 and has a plurality of touch electrodes 621 and a plurality of touch electrodes 623 interlaced with each other. The touch electrodes 621 extend, for example, in a vertical direction (which is exemplarily as shown in FIG. 6), and the touch electrodes 622 extend, for example, in a horizontal direction (which is exemplarily as shown in FIG. 6).

The display panel 610 has a plurality of pixels 660 and a common electrode 670. The common electrode 670 is configured to receive a common voltage Vcom and transmit the common voltage Vcom to the pixels 660. The source driver 630 is coupled to the display panel 610 and configured to provide a plurality of current pixel voltages Vpx1 to the pixels 660 according to a frame data SD received thereby, so as to drive the display panel 610 to display an image according to the frame data SD. In the present embodiment, when voltages applied to the pixels 660 are changed from previous pixel voltages Vpx2 to current pixel voltages Vpx1, the source driver 630 determines whether to insert at least one intermediate voltage level Vm between each of the current pixel voltages Vpx1 and the corresponding previous pixel voltage Vpx2 according to each of the current pixel voltages Vpx1 and the corresponding previous pixel voltage Vpx2. Therein, the source driver 630 has the same function as the source driver 130 of the embodiment illustrated in FIG. 1, and thus, details with respect to the operation thereof will not repeatedly described.

Referring to FIG. 6, when a touch operation is performed on the touch display 600, the touch driving unit 640 sequentially outputs a touch driving signal SDT to each of the touch electrodes 623, and each of the touch electrodes 621 correspondingly provides a touch sensing signal SST. The touch sensing unit 650 may identify positions of touch points on the touch panel 620 according to the received touch sensing signals SST and outputting timings of the touch driving signals SDT.

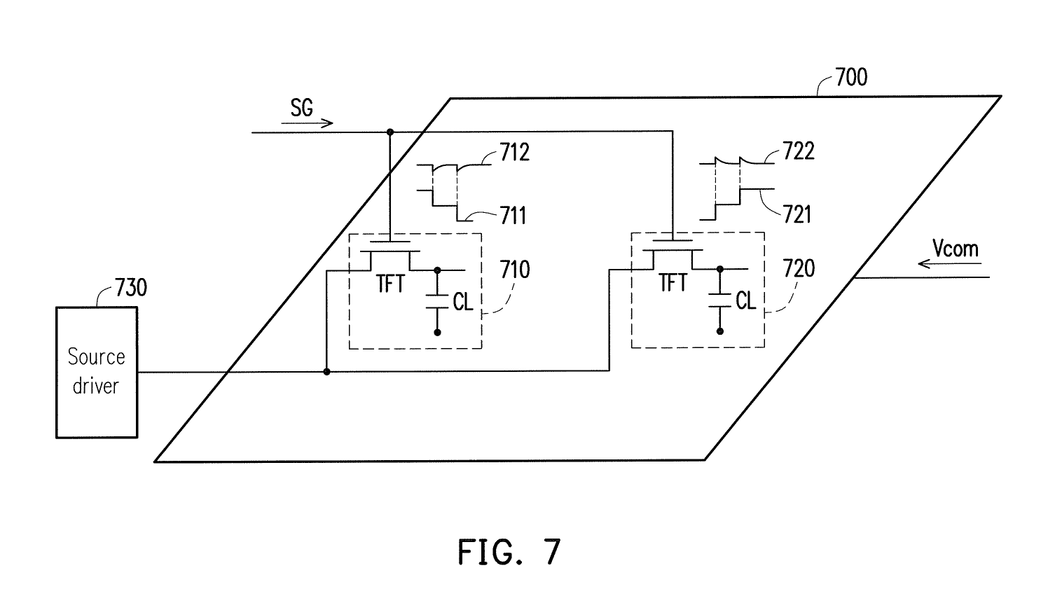

Meanwhile, the touch display 600 of the present embodiment may provide the pixel voltages stepwise, so as to achieve an effect of reducing noise energy of the display panel 620. For example, FIG. 7 is schematic diagram illustrating an example of driving the pixels according to an embodiment of the invention. With reference to FIG. 7, pixels 710 and 720 are coupled to a common electrode 700. The common electrode 700 is configured to receive a common voltage Vcom to provide the common voltage Vcom to the pixels 710 and 720. Each of the pixels 710 and 720 includes a thin film transistor TFT and a liquid crystal (LC) capacitor CL. The pixels 710 and 720 respectively receive corresponding pixel voltages (e.g., Vpx1, Vpx2) from a source driver 730 and control the thin film transistors TFT based on the control of a gate driving signal SG to turn on the pixels 710 and 720. Thereby, the corresponding pixel voltages (e.g., Vpx1, Vpx2) are respectively transmitted to the LC capacitors CL of the pixels 710 and 720 to display corresponding the image on the display panel in corresponding brightness, wherein the gate driving signal SG may be provided by a gate driver (not shown), which construes no limitations to the embodiments of the invention.

When the pixel 710 receives a pixel voltage which stepwise declines like a waveform 711, the affection to the touch electrodes 621 is like two negative pulses (appearing like a waveform 712). When the pixel 720 receives a pixel voltage which rises stepwise like a waveform 721, the affection to the touch electrodes 621 is like two positive pulses (appearing like a waveform 722). Referring to FIG. 7, during the process of the pixel voltage raising and declining, intermediate voltage levels (shown like the waveforms 711 and 721, for example) are inserted to mitigate the affection caused to the touch electrodes 621 due to the raising or declining of the pixel voltages, so as to reduce the nose energy accumulated on the touch panel 620.

Accordingly, by means of stepwise providing the pixel voltages, the touch display of the present embodiment can facilitate in preventing significant voltage variation from occurring in the pixel voltages, so as to mitigate the affection sensibility and accuracy and enhance operability for the touch operation.

To summarize, in the display and the touch display according to the embodiments of the invention, the intermediate voltages can be inserted according to the polarity change or variation degrees of the pixel voltages, so as to provide the pixel voltages stepwise. Thereby, the common electrode and the touch electrodes can be prevented from being affected due to overly large voltage variation occurring in the pixel voltages, such that the quality of displaying the image and the operability of the touch operation can be enhanced.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display, comprising:
a display panel, comprising a plurality of pixels and a common electrode receiving a common voltage; and
a source driver, coupled to the display panel and configured to provide a plurality of current pixel voltages to the pixels and determine whether to insert at least one intermediate voltage level between each of the current pixel voltages and a previous pixel voltage corresponding thereto based on the each of the current pixel voltages and the corresponding previous pixel voltage.

2. The display according to claim 1, wherein when a polarity of the each of the current pixel voltages is different from a polarity of the corresponding previous pixel voltage, the source driver inserts the at least one intermediate voltage level between the each of the current pixel voltages and the corresponding previous pixel voltage, and when the polarity of the each of the current pixel voltages is identical to the polarity of the corresponding previous pixel voltage, the source driver determines whether to insert the at least one intermediate voltage level between the each of the current pixel voltages and the corresponding previous pixel voltage according to a first voltage difference between the each of the current pixel voltages and the corresponding previous pixel voltage.

3. The display according to claim 2, wherein when the first voltage difference between the each of the current pixel voltages and the corresponding previous pixel voltage is greater than or equal to a threshold voltage, the source driver inserts the at least one intermediate voltage level between the each of the current pixel voltages and the corresponding previous pixel voltage, and when the first voltage difference between the each of the current pixel voltages and the corresponding previous pixel voltage is less than the threshold voltage, the source driver does not insert the at least one intermediate voltage level between the each of the current pixel voltages and the corresponding previous pixel voltage, wherein the threshold voltage is ½ of a second voltage difference between a minimum grayscale voltage and a maximum grayscale voltage, and a polarity of the minimum grayscale voltage is identical to a polarity of the maximum grayscale voltage.

4. The display according to claim 1, wherein a sum of a plurality of applying durations of the at least one intermediate voltage level is less than or equal to ⅓ of a data write period of each of the current pixel voltages.

5. The display according to claim 4, wherein the applying duration of the at least one intermediate voltage level is the same.

6. The display according to claim 4, wherein the applying duration of the at least one intermediate voltage level is not the same.

7. The display according to claim 1, wherein the source driver comprises:
a first latch, configured to receive a frame data to provide a first frame data;
a second latch, coupled to the first latch and configured to receive the first frame data, output and provide a second frame data;
a first digital-to-analog conversion circuit, coupled to the first latch and configured to provide the each of the current pixel voltages;
a second digital-to-analog conversion circuit, coupled to the second latch and configured to provide the corresponding previous pixel voltage;
a voltage-dividing circuit, coupled to the first digital-to-analog conversion circuit and the second digital-to-analog conversion circuit, and configured to perform voltage dividing according to a voltage difference between the each of the current pixel voltages and the corresponding previous pixel voltage to generate the at least one intermediate voltage level; and
a data control circuit, coupled to the first latch, the second latch and the voltage-dividing circuit to control the voltage-dividing circuit to output the each of the current pixel voltages or to sequentially output the at least one intermediate voltage level and the each of the current pixel voltages.

8. A touch display, comprising:
a display panel, comprising a plurality of pixels and a common electrode receiving a common voltage;
a touch panel, disposed on the display panel and comprising a plurality of touch electrodes; and
a source driver, coupled to the display panel and configured to provide a plurality of current pixel voltages to the pixels and determine whether to insert at least one intermediate voltage level between each of the current pixel voltages and a previous pixel voltage corresponding thereto based on the each of the current pixel voltages and the corresponding previous pixel voltage.

9. The touch display according to claim 8, wherein when a polarity of the each of the current pixel voltages is different from a polarity of the corresponding previous pixel voltage, the source driver inserts the at least one intermediate voltage level between the each of the current pixel voltages and the corresponding previous pixel voltage, and when the polarity of the each of the current pixel voltages is identical to the polarity of the corresponding previous pixel voltage, the source driver determines whether to insert the at least one intermediate voltage level between the each of the current pixel voltages and the corresponding previous pixel voltage according to a first voltage difference between the each of the current pixel voltages and the corresponding previous pixel voltage.

10. The touch display according to claim 9, wherein when the first voltage difference between the each of the current pixel voltages and the corresponding previous pixel voltage is greater than or equal to a threshold voltage, the source driver inserts the at least one intermediate voltage level between the each of the current pixel voltages and the corresponding previous pixel voltage, and when the first voltage difference between the each of the current pixel voltages and the corresponding previous pixel voltage is less than the threshold voltage, the source driver does not insert the at least one intermediate voltage level between the each of the current pixel voltages and the corresponding previous pixel voltage, wherein the threshold voltage is ½ of a second voltage difference between a minimum grayscale voltage and a maximum grayscale voltage, and a polarity of the minimum grayscale voltage is identical to a polarity of the maximum grayscale voltage.

11. The touch display according to claim 8, wherein a sum of a plurality of applying durations of the at least one intermediate voltage level is less than or equal to ⅓ of a data write period of the each of the current pixel voltages.

12. The touch display according to claim 11, wherein the applying duration of the at least one intermediate voltage level is the same.

13. The touch display according to claim 11, wherein the applying duration of the at least one intermediate voltage level is not the same.

14. The touch display according to claim 8, wherein the source driver comprises:
a first latch, configured to receive a frame data to provide a first frame data;
a second latch, coupled to the first latch and configured to receive the first frame data, output and provide a second frame data;
a first digital-to-analog conversion circuit, coupled to the first latch and configured to provide the each of the current pixel voltages;
a second digital-to-analog conversion circuit, coupled to the second latch and configured to provide the corresponding previous pixel voltage;
a voltage-dividing circuit, coupled to the first digital-to-analog conversion circuit and the second digital-to-analog conversion circuit, and configured to perform voltage dividing according to a voltage difference between the each of the current pixel voltages and the corresponding previous pixel voltage to generate the at least one intermediate voltage; and
a data control circuit, coupled to the first latch, the second latch and the voltage-dividing circuit to control the voltage-dividing circuit to output the each of the current pixel voltages or to sequentially output the at least one intermediate voltage level and the each of the current pixel voltages.
